(19) United States
(12) Patent Application Publication
(10) Pub. No.: US 2002/0023526 A1
(43) Pub. Date: Feb. 28, 2002

(54) Film cutter assembly

(76) Inventors: Paul Vegliante, Franklin Lakes, NJ (US); Sean Neiberger, Los Angeles, CA (US); Rudy Pavlik, Lincolnshire, IL (US); Ian Kaiser, La Canada, CA (US)

Correspondence Address: Mathews, Collins, Shepherd & Gould, P.A., Suite 306, 100 Thanet Circle, Princeton, NJ, 08540, US

(21) Appl. No.: 09/741,521

(22) Filed: Dec. 20, 2000

Related U.S. Application Data
(60) Provisional application No. 60/172,717, filed on Dec. 20, 1999.

(51) Int. Cl. B26D 1/06

(52) U.S. Cl. 83/614; 83/471.2; 83/578; 83/697

(57) ABSTRACT

The present invention relates to a film cutter assembly in which a blade housing slides along a pair of rails. The blade housing is formed of an upper portion for housing the blade. Either end of the upper portion has a rounded inclined shape from a bottom edge to form a sled shaped runner. The sled shaped runner extends beyond the blade such that the user is prevented from touching the blade. A lower portion of the blade housing slidables bilaterally in a cavity formed below the rails. A clearance is formed between the blade and the rails to allow the blade housing to easily slide over a film to be cut even if the film bunched or doubled over. The upper portion of the blade housing has a concave shape for allowing a user's fingers to easily grip the blade housing. Preferably, the rails are formed of a material which provides an attractive charge to attract the film to the rail and help hold the film flat before and after cutting. For example, the rails can be formed of flexible vinyl or acetal.

### BACKGROUND OF THE INVENTION

1. Field of the Invention

The present invention relates to a film cutter method and apparatus in which a cutting blade extends from the interior of a housing, the housing having a sled shaped runner and an adjustable clearance to an upper surface of a rail in which the housing is slidably moved, thereby effectively and expeditiously cutting film, such as food service wrap, even if the film is bunched or doubled over without injury to a user of the apparatus.

2. Related Art

The present invention relates to an improved film cutter for plastic wrap. Conventional plastic wrap has many uses for covering foods before putting them in a refrigerator, microwave or other storage means. Typically, conventional thin plastic wrap is rolled on a rod and dispensed by pulling outward a section thereof for use, the extended plastic wrap is then cut off by a blade or zig-zag cutting device attached along the edge of a box in which the roll of wrap is housed. The problem with these devices is that the thin plastic wrap is easily distorted by sticking to itself due to static electricity. Also, a user can cut themselves on the exposed blade.

U.S. Pat. No. 4,957,023 describes a wrap dispenser with an automatic cutting device. A cutting device is fixed on a mount and is able to be slidably moved along a fixed track by way of a transmission mechanism powered by a motor that is in turn actuated by a number of batteries. This patent has the drawback of being cumbersome and expensive to manufacture.

Other conventional attempts have included cutting apparatus having a plurality of guide wheels to travel in a channel beneath a cutting surface. U.S. Pat. No. 5,440,961 describes a film cutting apparatus in which a plurality of guide wheels are supported in a channel for guiding a cutting device during travel. A rotatable cutting wheel is disposed within a semi-circular housing. A top surface of a cutting plane is formed of a urethane tape to adhere the film to the surface during cutting. The above-described film cutter has the limitation that the guide wheels and rotating cutting wheel use complex mechanical interaction resulting in high manufacturing costs. This cutter also has the drawback that the urethane tape loses the ability with use to immobilize the film because of loss of the adhesiveness of the tape.

U.S. Pat. No. 4,197,774 describes a travelling cutter assembly in which an elongated track has a slot for slidably receiving and returning a cutter slide therein. The track has roughened upper surface elements. A cutting element includes a housing having a smooth lower surface that extends laterally for locally immobilizing the sheet by pressing it against the roughened track surface. The use of a roughened surface for immobilizing a material has the shortening that the film can only be immobilized against the surface upon application of pressure between the cutting device and the surface.

U.S. Pat. No. 5,398,576 describes a cutting device having a positioning unit formed of two elongated vertical side walls interconnected to a horizontal top wall to define a sliding space between the vertical side walls and under the top wall. A cutter includes a sliding body with two vertical plates and two horizontal plates extending from the vertical plates under the horizontal top wall. A blade is mounted in a notch of the cutter. The blade extends rearwardly and downwardly from the front end surface. This patent has the disadvantage of exposure of the blade to a user and difficulty of the blade cutter bunched or misaligned film.

It is desirable to provide an improved film cutter apparatus overcoming the above-described deficiencies in which the apparatus can be used to conveniently and effectively cut film even if the film is bunched or doubled over while providing safety to the user.

### SUMMARY OF THE INVENTION

The present invention relates to a film cutter assembly in which a blade housing slides along a pair of rails. The blade housing is formed of an upper portion for housing the blade. Either end of the upper portion has a rounded inclined shape from a bottom edge to form a sled shaped runner. The sled shaped runner extends beyond the blade such that the user is prevented from touching the blade. A lower portion of the blade housing slides bilaterally in a cavity formed below the rails. A clearance is formed between the blade and the rails to allow the blade housing to easily slide over a film to be cut even if the film bunched or doubled over.

The upper portion of the blade housing has a concave shape for allowing a user's fingers to easily grip the blade housing. Preferably, the rails are formed of a material which provides an attractive charge to attract the film to the rail and help hold the film flat before and after cutting. For example, the rails can be formed of flexible vinyl or acetal.

The rails can be attached or integral with an elongated rail base. An end cap can be releasably attached to either end of the elongated rail base to provide a bumper and release upon excessive pressure applied to the blade housing. A u-shaped guide formed in the elongated rail base can receive an edge of a carton for clamping the apparatus to the carton. A depression in the rear surface of the elongated rail base is adapted to receive a cover of the carton.

The invention will be more fully described by reference to the following drawings.

### BRIEF DESCRIPTION OF DRAWINGS

FIG. 1 is a front and side elevational view of a film cutter assembly in accordance with the teachings of the present invention.

FIG. 2 is a side sectional view of the film cutter assembly in accordance with the teachings of the present invention.

FIG. 3 is a side sectional view of a blade housing showing movement of the blade housing between end positions of an elongated rail base.

FIG. 4 is a top plan view of the film cutter assembly shown in FIG. 1.

FIG. 5 is an end view of the film cutter assembly viewed from an end having the end cap removed.

FIG. 6 is a side sectional view of the blade housing attached to a film carton.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

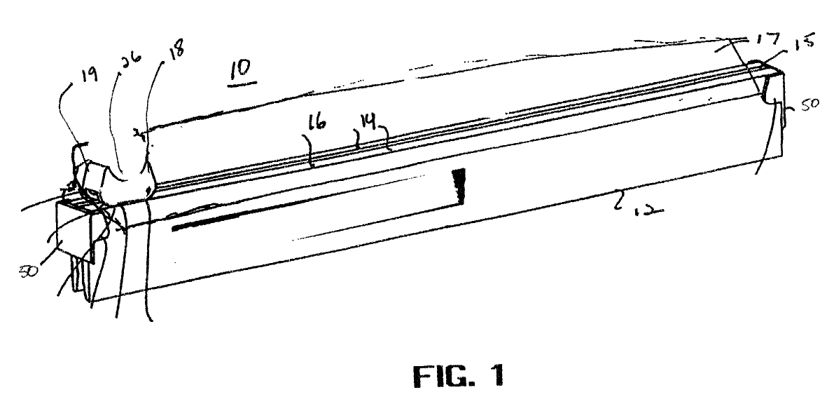

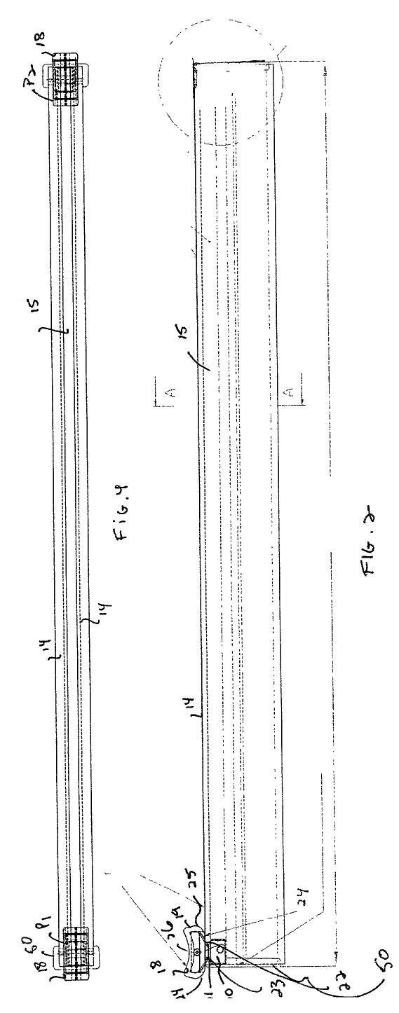

FIGS. 1 and 2 illustrate film cutter assembly 10 in accordance with the teachings of the present invention. Elongated rail base 12 is coupled to a pair of rails 14 along top surface 16. Alternately, rails 14 are integral with elongated rail base 12. Cavity 15 is formed below rails 14 and extends between rails 14. Plastic film 17 is dispensed from a roll (not shown) and is pulled across rails 14. Elongated rail base 12 can have a length corresponding to the width of any size film. For, example, for a 12, 18 or 24 inches wide film elongated rail base 12 respectively has a length of about 13.2, about 19.2 or about 25.2 inches.

Preferably, elongated rail base 12 is formed of a first material having durability properties. For example, elongated rail base 12 can be formed of rigid vinyl such as 87549 manufactured by Geon or polyvinyl chloride (PVC). Preferably, rails 14 are formed of a second material which provides an attractive charge to attract film 17 to rails 14 and to help hold film 17 flat before and after cutting. Suitable materials that can be used to provide an attractive force, such as a static charge, include a material having a shore A, durometer 75 or other flexible vinyl materials such as vinyl manufactured be Teknor as Apex 3300-75 NT, acrylic or PVC. Co-extrusion can be used to form elongated rail base 12 and rails 14 from two different materials.

Blade housing 18 is formed of upper portion 19 and lower portion 20. Middle portion 21 connects upper portion 19 to lower portion 21. Upper portion 19 of blade housing 18 houses blade 22. Lower portion 20 of blade housing 18 is received in channel 15 of elongated rail base 12.

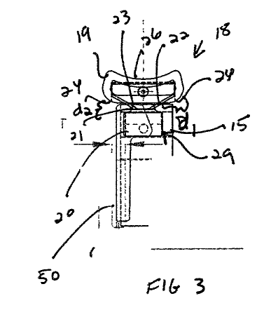

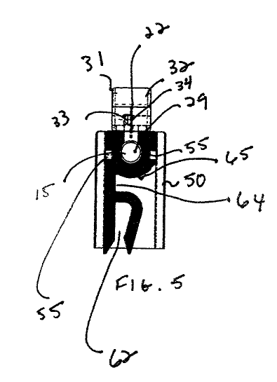

Bottom surface 23 of upper portion 19 includes bottom edge 24 which protrudes from blade 22 and prevents a user from contacting blade 22. Blade 22 protrudes from bottom surface 23 at a distance d1 behind end surface 25, as shown in FIG. 3. End surface 25 is upwardly inclined and rounded from bottom edge 24. End surface 25 and bottom edge 24 form a sled shaped runner to allow upper portion of blade housing 18 to slide back and forth along rails 14 between position p1 and position p2 and act in conjunction with rails 14 to keep film 17 from “bunching up” and allow film 17 to remain flat during sliding of blade housing 18 along rails 14.

Preferably, blade housing 18 is formed of a flexible material having good lubricity for sliding along top surface 16 of rails 14 and within cavity 15. For example suitable materials for blade housing 18 are acetal, such as RTP 801 manufactured by DEL or silicon.

Upper portion 19 of blade housing 18 includes grip surface 26. Preferably, grip surface 26 is contacted by a finger of the user for moving blade housing 18. Grip surface 26 has a concave shape for allowing a user's finger to easily grip blade housing 18 and maintains a user's point of contact centrally on the top of the blade housing 18, thereby preventing rocking or teetering of blade housing 18.

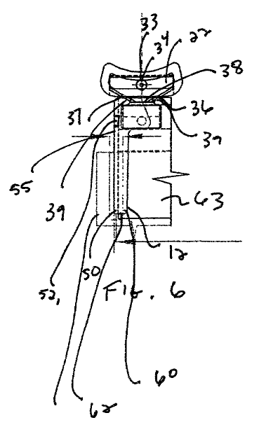

Lower portion 20 of blade housing 18 forms a tracking device 29, as shown in FIG. 3. Tracking device 29 is received in cavity 15 for bilaterally sliding along cavity 15. Preferably, tracking device 19 has a tubular shape which slides in cavity 15 having a corresponding tubular shape, as shown in FIG. 5. Middle portion 21 is selected to determine the distance d2 between tracking device 29 and blade 22. Distance d2 is selected to provide a predetermined clearance between blade 22 and rails 14 to allow blade housing 18 to be used with bunched or doubled over film.

Blade housing 18 can be formed of a two piece construction having a left section 31 and a right section 32, as shown in FIG. 6. Blade 22 is positioned between left section 31 and right section 32. Blade 22 is attached to left section 31 and right section 32 with rivet 33 extending through aperture 34 of blade 22. Rivet 33 secures blade 22 to a core of blade housing 18 for ensuring safety.

Blade 22 can have angled side edges 36, 37. For example, side edges 36, 37 can be angled at a 30° angle from bottom surface 38 of blade 22. Cutting portion 39 extending from blade housing 20 is used to cut plastic film 17. The blade angle provides optimal performance of cutting and reduces exposure of blade 22 to the user to allow blade 22 to cut plastic film 17 and not a user's fingers. For example the preferred blade angle optimizes cutting of PVC and polyethylene film. Alternatively, blade 22 can have a rounded shape with a portion of the rounded shape forming the cutting portion. A suitable material for blade 22 is stainless steel.

End cap 50 is formed of a pair of male protrusions 52, which are integral with edge 55, as shown in FIG. 1 and FIG. 5. Male protrusions 52 snap onto female receptacles 55 positioned at both ends of elongated rail base 12. End cap 50 acts as a bumper and releases from elongated rail base 12 if too much pressure is exerted against blade housing 18 at either end of elongated rail base 12. Accordingly, blade housing 18 will remain intact and be removed from elongated rail base 12 if excessive force is applied to blade housing 18. A suitable material for end cap 50 is an acetal such as 2558-112 manufactured by Makrabon or polycarbonate. Alternative methods can be used including a rivet, plug, glue, pinching, piercing or other applications known in the art to prevent blade housing 18 from escaping elongated rail base 12.

Rear edge 60 of elongated base rail 12 includes extension 62 forming a “u” shape, as shown in FIG. 5 and 6. A side edge of a carton 63 is received in the “u” shape. Depression 64 is formed in rear edge 60 between extension 62 and outer surface 65 of channel 15. Depression 64 is adapted to receive a lid of the carton (not shown) and prevent movement thereof.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

We claim:

1. A film cutter apparatus comprising:
an elongated rail base;
a pair of rails formed at a top surface of said elongated rail base and a channel formed within said rail base and between said rails; and
a blade housing formed of an upper portion and a lower portion;
said upper portion of said blade housing a blade, a bottom edge of said upper portion of said blade housing protruding on either end from said blade and an end surface being rounded and inclined upwardly and from either end of said bottom edge;
said lower portion of said blade housing slidably moving in said channel.

2. The film cutter of claim 1 wherein said upper portion of said blade housing has a grip surface, said grip surface having a concave shape.

3. The apparatus of claim 1 wherein said rails are formed of a material which is adapted to provide a positive charge to film received over said rail.

4. The apparatus of claim 3 where said rail is formed of a material having a shore A durometer.

5. The apparatus of claim 3 where said rail is formed of a first material selected from the group consisting of flexible vinyl, acrylic or polyvinyl chloride.

6. The apparatus of claim 5 wherein said elongated base rail is formed of a second material of rigid vinyl or PVC.

7. The apparatus of claim 6 wherein said first material is coextruded with said second material.

8. The apparatus of claim 1 wherein said blade housing is formed of a flexible material providing lubricity.

9. The apparatus of claim 8 wherein said blade housing is formed of acetal or silicon.

10. The film cutter of claim 1 wherein said blade housing is formed of a left section and a right section, said blade is attached to said left section and said right section with a rivet extending through an aperture of said blade.

11. The apparatus of claim 1 where said blade is angled from said bottom edge of said upper portion.

12. The apparatus of claim 11 wherein said blade is angled at a 30° angle from said bottom edge of said upper portion.

13. The apparatus of claim 1 wherein said lower portion is formed of a tracking device for slidably moving in said channel.

14. The apparatus of claim 13 wherein said tracking device is formed of a tubular base, a middle portion attaches said lower portion to said upper portion and said tubular base sliding in said cavity having a corresponding tubular shape.

15. The apparatus of claim 14 wherein said middle portion has predetermined length to provide a predetermined clearance between said blade and said rails.

16. The apparatus of claim 1 further comprising a pair of end caps adapted to be releasably attached to either end of said elongated rail base for providing a bumper of elongated rail base and releasing upon application of excessive force.

17. The apparatus of claim 16 wherein said end cap includes a pair of male protrusions which engage a pair of respective female receptacles on a side surface of said elongated rail base.

18. The apparatus of claim 1 wherein a rear edge of said elongated rail base includes a depression, said depression being adapted to receive a cover of a carton of said film.
